(19) United States
(12) Patent Application Publication
(10) Pub. No.: US 2011/0162545 A1
(43) Pub. Date: Jul. 7, 2011

(54) PRINTING UNIT, AND DEVICES AND METHODS FOR CONTROLLING THE TEMPERATURE OF A PRINTING UNIT

(76) Inventor: Claus August Bolza-Schünemann, Würzburg (DE)

(21) Appl. No.: 12/998,067

(22) PCT Filed: Sep. 4, 2009
(86) PCT No.: PCT/EP2009/061475

§ 371 Date: Mar. 15, 2011

(30) Foreign Application Priority Data
Sep. 15, 2008 (DE) 10 2008 042 090.5

(51) Int. Cl. B41F 5/04

(52) U.S. Cl. 101/219

(57) ABSTRACT

A printing unit is comprised at least of a plurality of printing machines which are arranged on the same side of a web to be printed. Each such printing machine includes an inking unit having at least one roller, and a dampening unit. Rollers of the inking units of several of the printing machines, which are arrayed on the same side of the web to be printed, are in thermal contact with the same temperature-control medium unit for controlling the temperature of the rollers. The temperature control medium circuit is configured as an inner temperature-control medium circuit having substantially constant circulating volumetric flow rate of a temperature-control medium.

### CROSS-REFERENCE TO RELATED APPLICATIONS

This application is the U.S. national phase, under 35 U.S.C. 371, of PCT/EP2009/061475, filed Sep. 4, 2009; published as WO 2010/029023 A1 on Mar. 18, 2010, and claiming priority to DE 10 2008 042 090.5, filed Sep. 15, 2008, the disclosures of which are expressly incorporated herein by reference.

### FIELD OF THE INVENTION

The invention relates to a printing unit and to devices and methods for controlling the temperature of a printing unit. The printing unit has at least a plurality of wet offset printing couples that are arranged on the same side of a web to be imprinted. Each of the printing couples includes an inking unit with at least one roller and a dampening unit. A method is provided for controlling the temperature of various rollers of the printing unit.

WO 2005/097504 A2 describes a printing unit embodied as a printing tower, which has at least a plurality of printing couples arranged on the same side of a web to be imprinted, wherein each of the printing couples has an inking unit with at least one roller, and in some embodiments has a dampening unit.

DE 694 02 737 T2 describes a temperature-controlled system for printing presses having a plurality of printing couples designated as “towers,” each of which prints one ink. For controlling the temperature of all the printing couples, which are spaced from one another horizontally, a combined cooling and heating system is provided, wherein a compressor selectively provides temperature control medium for cooling and for heating purposes to control the temperature of inking unit rollers of multiple printing couples. This is accomplished by selectively charging a heat exchanger with temperature control medium which has been compressed, cooled in a condenser, and finally expanded, or alternatively with temperature control medium which has not been expanded, and is therefore hot, via a bypass. In the heat exchanger, a secondary temperature control medium circuit, which passes through the rollers, is then either cooled or heated. The temperature of each of the individual rollers is controlled by regulating the flow in the temperature control medium circuit specific to the roller by means of a temperature sensor and a control valve assigned to each individual roller.

EP 1 870 238 B1 relates to a system for controlling the temperature of a printing press comprising multiple printing units, each of said printing units comprising multiple dry offset printing couples, each having an inking unit with a screen roller, the temperature of which is to be controlled. Each screen roller is temperature controlled by a separate temperature control medium circuit, driven by a pump, however, in the event of a malfunction, said temperature control medium circuits can be interconnected in pairs at each blanket-to-blanket printing point for temperature control. The respective temperature control medium circuit can be selectively connected via valves to a hot water circuit or a cooling circuit, from which the necessary amount of heating or cooling medium can be added to or exchanged with the respective temperature control medium circuit, via a remotely actuable metering valve, for the proper temperature control of said circuit. The forme cylinders of the printing unit can be temperature controlled in pairs, individually, or in larger groups of four, six or eight forme cylinders, via a shared temperature control medium circuit which is different from the inking roller circuits.

EP 06 52 104 A1 discloses controlling the temperature of ink distribution cylinders of an I-printing unit, wherein the temperature of the distribution cylinders of the two printing couples is controlled via a shared temperature control medium line. The temperature is regulated by the amount of temperature control medium that is circulating, wherein a control valve regulates the flow on the basis of a temperature measurement indicating the temperature of the distribution cylinder.

EP 0 383 295 A2 discloses controlling the temperature of a roller by means of one primary and one secondary circuit, wherein temperature control medium can be exchanged via a four-way valve.

EP 1 008 448 A1 discloses a device for controlling the temperature of a printing press with a temperature control circuit, which contains a pump and a temperature sensor and in which a consumer of the printing press can be integrated for controlling the temperature of said consumer. The temperature control circuit is intended to maintain the temperature of the consumer at a set value, within extremely narrow tolerance limits, for example, +/−0.25° C. On the basis of the actual temperature value, a circulating amount can be replaced with temperature control fluid from a temperature control fluid source.

GB 545 346 A discloses a device for heating ink in the printing couple of a printing press, wherein the ink in the storage vessel and the rollers of the printing couple are heated to 80° C. or more using hot fluid. For this purpose, a supply line leading from the tank and a return line leading back to the tank are provided, with lines for the individual rollers and the ink storage vessel branching off from said supply and return lines.

DE 44 29 520 A1 discloses in one embodiment example controlling the temperature of distribution cylinders for multiple inks of a multicolor printing press via branches of a same temperature control circuit, wherein in each branch, a bypass line with valve is provided. The temperature of the temperature control medium circulating in the circuit is controlled in this case by heat exchange via a heat exchanger with refrigerant from a cooling unit.

### SUMMARY OF THE INVENTION

The problem addressed by the invention is that of devising a printing unit and a method for effectively controlling the temperature of a printing unit.

The problem is solved according to the invention by the provision of an inner temperature control medium circuit, including a pump and a temperature sensor. Rollers of inking units of the multiple printing couples of the printing unit, and which are arranged on the same side of the web to be imprinted, are all in thermal contact with the same inner temperature control medium circuit for controlling the temperatures of those rollers. The inner temperature control medium circuit is embodied with a substantially constant circulating volumetric flow rate of a temperature control medium which is circulating in the inner temperature control medium circuit. When that temperature control medium exceeds a threshold temperature, temperature control medium at a lower temperature, and coming from a supply circuit can be exchanged by addition and removal. The temperature control medium from the supply circuit, which is an outer temperature control medium circuit, can be metered into the inner circuit using at least one remotely actuable, multiway mixing valve.

The advantages that are achievable with the invention consist particularly in that a printing unit, particularly a printing tower that can be operated using a wet offset process, can be produced at low cost with minimized fluctuation in product quality, and/or the temperature of inking units of a printing unit can be satisfactorily controlled at low technical expense using minimized amounts of operating media.

A further advantage is that the temperature of the printing unit is controlled in such a way that the amount of cooling medium, for example, cold water, that is required and is circulating is reduced and/or that a greater difference in temperature between the outer and inner temperature control circuits can be achieved.

In one advantageous embodiment, the printing unit or the units thereof to be temperature controlled is equipped with its own circuit having a circulating pump, a mixer, particularly motorized, and a regulator—comparable to the system of circulation in a central heating system for a building—for keeping the printing unit at a substantially constant (at least within a permissible range) temperature of between 23° C. and 35° C., for example, particularly 25° C. to 30° C., and when the circuit temperature heats up, for mixing in colder fluid, for example, cold water, from a cold water circuit.

In one advantageous embodiment, the circuit uses the permanent heat from equipment cabinets and/or drive units and/or pumps to ‘heat’ the inking unit when it is off-line and/or during the start-up phase. Once the printing unit begins to produce more heat, cold water is added via the regulator, and the circulation temperature within the printing unit and/or within the circuit is held constant (or at least within the permissible range).

The present solution is not focused primarily on directing the printing process on the basis of temperature, for example (with dynamic changes in set values and very narrow limits, as is the case, for example, with controlling ink flow in the dry offset process and/or when screen rollers are used). Rather, it focuses primarily on creating constant pressure conditions in—particularly high speed—rotary printing presses at limited expense and/or, for example, on the possibility of completely producing the temperature control system within the “printing unit” module during assembly of the unit at the plant, up to its connection on site to a supply circuit. With the proposed temperature control system, fluctuations in the quality of the printed product and therefore amounts of waste (e.g., ink and paper consumption) can be reduced while simultaneously minimizing the consumption of operating medium (e.g., fresh water) by using closed circuits.

Therefore, the proposed temperature control system is particularly advantageous in connection with printing units operated in wet offset, i.e., with printing units having forme cylinders which interact with both an inking unit and a dampening unit.

### BRIEF DESCRIPTION OF THE DRAWINGS

Embodiment examples of the invention are illustrated in the set of drawings and will be specified in greater detail in what follows.

The drawings show:

FIG. 1 an embodiment example of a system for controlling the temperature of I-printing units;

FIG. 2 an embodiment example of a system for controlling the temperature of printing towers;

FIG. 3 a) a first and b) a second schematic example of the configuration of line branches of the inner temperature control medium circuit.

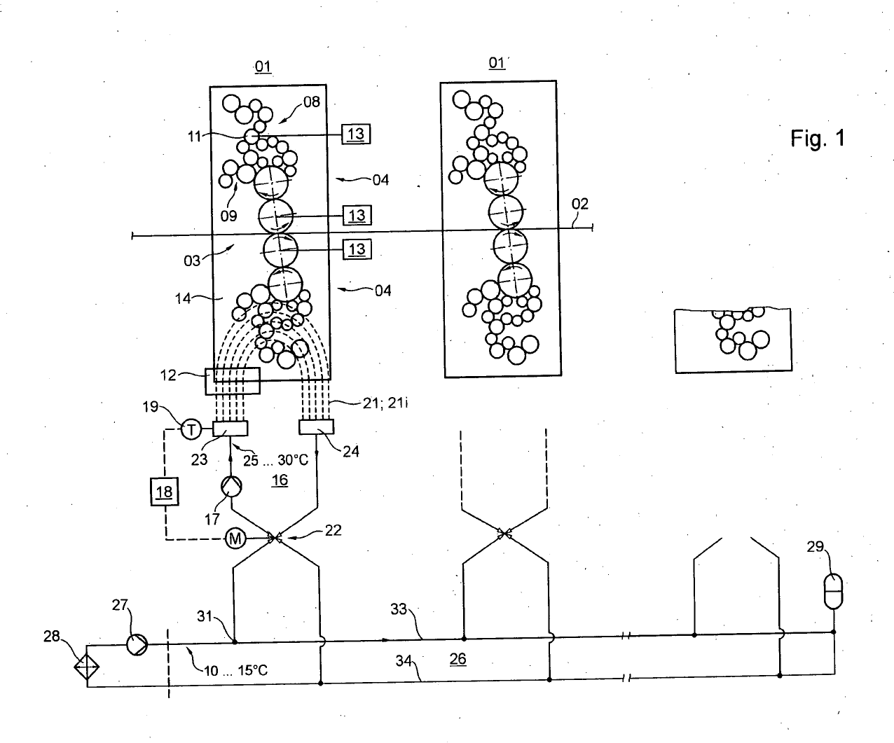

A printing press, for example, a web-fed rotary printing press, has a plurality of printing units 01, with which a print substrate 02, for example, a sheet-type print substrate 02 or a web 02, particularly a paper web, can be imprinted on one or both sides in one or multiple colors. In the example shown in FIG. 1, a plurality of printing units embodied as I-printing units are arranged side by side in a web path that extends substantially horizontally, and each unit in sequence applies one print image in one ink to both sides of the print substrate 02. Each of the printing units 01 has two printing couples 04, in this case interacting with one another as blanket-to-blanket printing units 03, each with printing couple cylinders 06; 07, one embodied as forme cylinder 06 and one embodied as transfer cylinder 07, and with an inking unit 08 that interacts with the forme cylinder 06. In the illustrated embodiment, the printing couples 04 are embodied as wet offset printing couples 04 and have a dampening unit 09 that interacts with the forme cylinder 06. The aforementioned components are mounted together as a structural unit in each printing unit 01, in or on a frame.

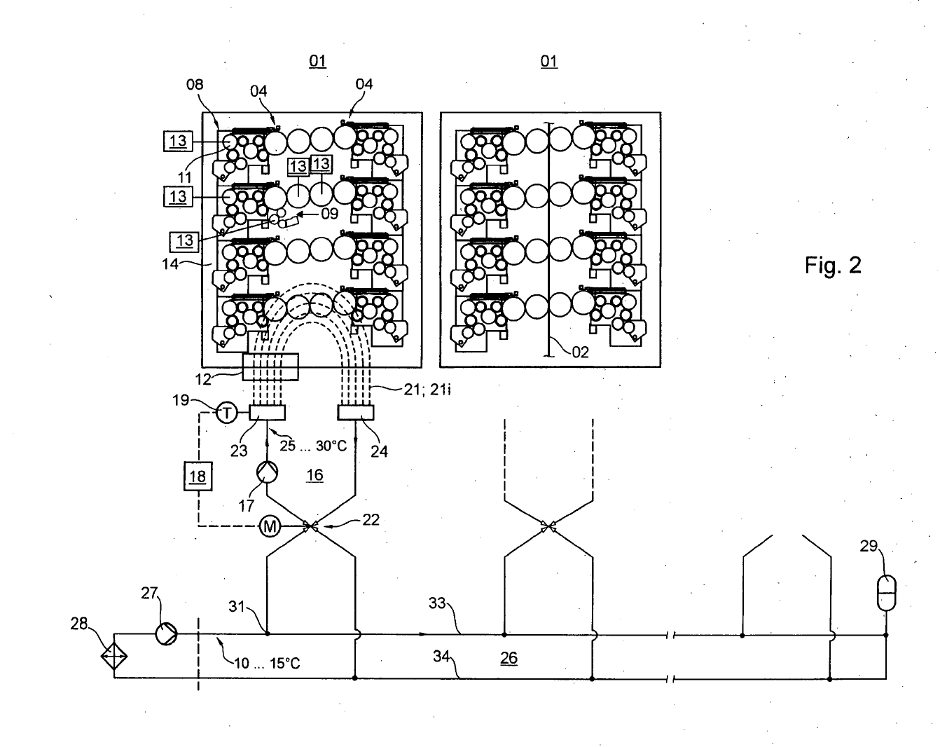

In the particularly advantageous embodiment example of FIG. 2, a plurality of blanket-to-blanket printing couples arranged one above the other form a printing unit 01, embodied as a printing tower 01, for example, an “eight-couple tower,” wherein when the web path extends substantially vertically, one print image in one ink is applied to both sides of the print substrate 02 in sequence. The printing unit 01 embodied here as a printing tower can also have two stacked H-printing units (each with four printing couples 04) or two stacked satellite printing units (each with four printing couples 04) or at least four stacked bridge-type printing units in n-, u- or linear arrangement (each with two printing couples 04). In principle, the printing units 01 could be embodied without dampening units, however in an advantageous embodiment, said units have one dampening unit 09 in addition to the inking unit 08, and have at least one dampening agent source, in addition to an ink source, said dampening agent source being different from the ink source, for each printing couple 04. In FIG. 2, this is illustrated by way of example for all printing couples 04 in only the left printing tower 01.

As is indicated by way of example by shading in only one of the printing couples 04 in FIG. 1 and FIG. 2, each of the inking units 08 has at least one, but particularly, as in the inking unit of FIG. 2, at least two, and, in the inking unit of FIG. 1, even three rollers 11, for example, rollers 11 of the same type, which can and/or will be temperature controlled using liquid temperature control medium. The rollers 11 are embodied as distribution cylinders 11 that can oscillate in the axial direction, for example.

For each printing unit 01, at least one electrical control and/or supply unit 12, for example, ordinarily referred to as equipment cabinet 12, is provided in a space that can be suitably closed off, for example.

For each printing unit 01, at least one drive unit 13 is provided for driving the rotation of the printing couple cylinders 06; 07 and, if applicable, the secondary units such as inking and/or dampening unit 08; 09. In further developments, multiple drive units 13 can also be provided, for example, one drive unit 13 per printing couple 04 or one drive unit 13 per printing couple cylinder pair 06, 07 or advantageously per printing couple cylinder 06; 07, in which case the inking and/or dampening unit 08; 09 is/are driven by a printing couple cylinder 06; 07, or advantageously by at least one additional, separate drive unit 13 each, for example. Advantageously, at least one of the distribution cylinders 11 of the inking unit 08 is rotationally driven by a drive unit 13 which is mechanically independent of the printing couple cylinders, and if applicable, a distribution cylinder of the dampening unit 09 is also rotationally driven by a drive unit 13 which is mechanically independent of the printing couple cylinders.

The drive unit 13 comprises, for example, a motor with a drive controller and/or an output component. Preferably, at least one drive unit 13, for example, at least the drive unit(s) 13 that drive(s) the printing couple cylinders 06; 07, but particularly the drive units 13 that rotationally drive all the printing couple cylinders 06; 07 along with inking and optionally dampening units 08; 09 operationally, i.e., in production, are embodied as temperature controllable using liquid temperature control medium.

The two printing couples 04 of an aforementioned I-printing unit are mounted in or on a shared frame 14. In the case of the tower construction illustrated in FIG. 2, for example, at least four printing couples, in this case advantageously eight printing couples 04, are mounted in or on a shared frame 14.

To keep the printing conditions for the ink constant, a separate temperature control medium circuit 16, in this case, inner temperature control medium circuit 16 (or “secondary circuit”), is provided for each printing unit 01. The temperature control medium of this inner temperature control medium circuit 16 circulates in this circuit—similarly to a building heating system—in a quasi-closed circuit. Only if the circuit temperature deviates from a set value are corrections made from the outside by adding and removing small amounts.

At least one roller 11 to be temperature controlled in each printing couple 04 of the printing unit 01, particularly at least all rollers 11 of the same type in the printing unit 01, preferably all rollers 11 to be temperature controlled in the inking units 08 of the printing unit 01, are connected to this inner temperature control medium circuit 16, and are in thermal contact with the relevant inner temperature control medium circuit 16 for controlling the temperature of said rollers. Thermal contact is established, for example, via means appropriate for enabling temperature control medium to flow through the roller 11, however said means are not described in greater detail here.

In the preferred embodiment, one or more of the drive units 13 that operationally drive the rotation of the printing couple cylinders 06; 07 and/or inking and/or optionally provided dampening units 08; 09 are also connected for the purpose of heat exchange with the temperature control medium in this inner temperature control medium circuit 16—for example, via corresponding contact heat exchangers, such as a cooling medium coil or a corresponding space through which cooling medium flows, for example. Additionally or alternatively, the equipment cabinet 12 can also be integrated into the inner temperature control medium circuit 16. This can be accomplished, for example, via suitable means of heat transfer, such as thermal contact with a base or a mounting plate that supports the electronic components, for example.

The inner temperature control medium circuit 16 has a pump 17, for example, circulating pump 17, which drives the temperature control medium, a temperature sensor 19 connected by means of electrical signals to a control device 18, at least one line 21 or line branch 21.i connected to one or more of the components (e.g., roller(s) 11 and/or drive unit(s) 13) to be temperature controlled, and at least one remotely actuable valve 22, for example, a multiway valve, particularly a four-way mixing valve 22, also connected by means of electrical signals to the control device 18, by means of which valve temperature control medium can be metered at least into the inner temperature control medium circuit 16. The control device 18 acts on a drive unit for the valve 22, which can be embodied, for example, as a motor or as a magnetically actuable opening/closing device.

The control devices 18 can receive its predefined set value and/or predefined maximum value for the temperature to be maintained via a shared controlling and/or regulating unit, which is not shown. In an embodiment not illustrated here, a particularly electric heating device (e.g., a “heating cartridge”) can be provided in the inner temperature control medium circuit 16, for example, between valve 22 and consumer (roller 11) to be temperature controlled, particularly between valve 22 and a feed flow distributor 23, which will be specified in greater detail below, with which heating device, for example, additional heat can be introduced into the inner temperature control medium circuit 16 temporarily before and/or during start-up of the press. This heating device, if provided, is then also connected by means of electrical signals to the control device 18 and can be controlled by said device with respect to the set or maximum value to be maintained, in this case, for example, the target value.

In principle, all components to be temperature controlled by the inner temperature control medium circuit 16, i.e., rollers 11 and/or equipment cabinet 12 and/or drive units 13, can be connected in series by a single line 21. However, in the case of particularly multiple rollers 11 to be temperature controlled, it is advantageous, in terms of avoiding an unduly large temperature gradient between the first and last component, for the temperature control medium circuit 16—for example, downstream of the pump 17—to be divided by a feed flow distributor 23 into multiple parallel lines 21.i, for example, line branches, or branches 21.i, which are then recombined, following thermal contact with the components (11; 12; 13) to be temperature controlled, by a return flow collector 24. Feed flow distributor 23 and return flow collector 24 are then components of the inner temperature control medium circuit 16 and are preferably assigned solely to the printing unit 01 that is to be temperature controlled by said temperature control medium circuit 16.

If one or more electric drive units 13 of this printing unit 01 and/or the equipment cabinet 12 are also in thermal contact with the inner temperature control medium circuit 16, and if, at least during the off-line or start-up phase, the exhaust heat from said units is to be used for preheating the rollers 11, it can be advantageous for a drive unit 13 and/or the equipment cabinet 12 to also be thermally coupled into each line branch 21.i that controls the temperature of at least one roller 11.

In FIGS. 1 and 2, the coupling of the inner temperature control medium circuit 16 via one or more lines 21; 21.i is indicated merely schematically by dashed lines.

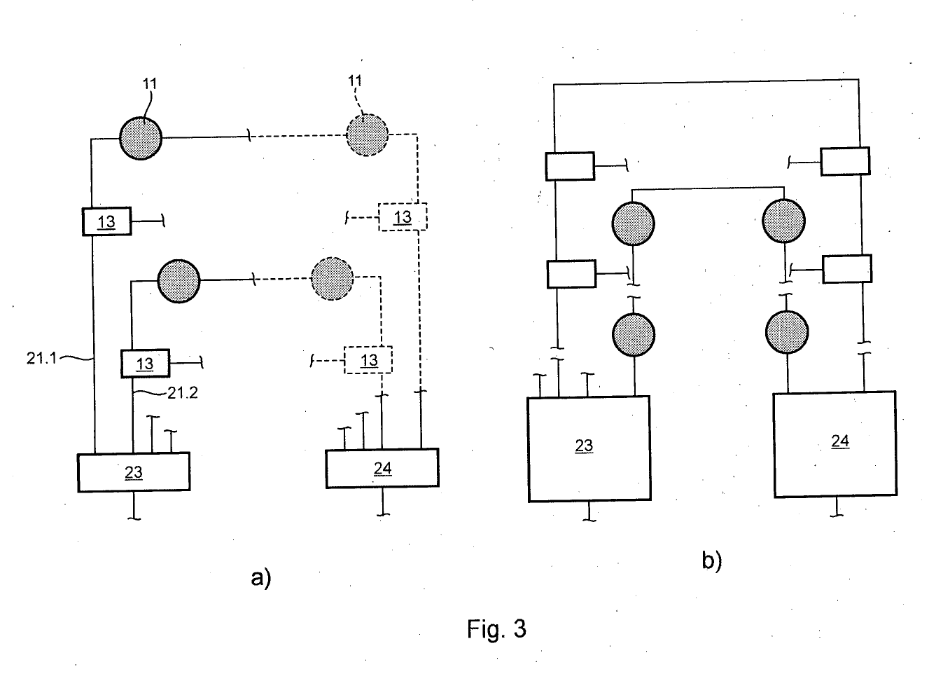

FIG. 3 a) shows an embodiment, by way of example, wherein a drive unit 13 is also incorporated into at least one, particularly all, line branches 21.i that control the temperature of at least one roller 11. In this case, downstream of the feed flow distributor 23, prior to contact with a roller 11, thermal contact with a drive unit 13 (and/or the equipment cabinet 12) is preferably provided first.

FIG. 3 b) shows an embodiment having a line branch 21.1 that incorporates only drive units 13. During an off-line phase or during start-up of the—still “cold”—printing unit 01, said line branch introduces heat into the temperature control medium circuit 16. The feed flow distributor 23 and/or return flow collector 24 can then optionally assume the function of a mixing chamber between the cold and warm circulating streams.

Between the two cases depicted in FIGS. 3 a) and 3 b), embodiments that combine the line branches 21.i illustrated in FIG. 3 a) and FIG. 3 b) are also possible, depending on existing structural conditions and/or energy requirements.

In one advantageous embodiment of the printing unit 01 embodied as a printing tower 01, the rollers 11 to be temperature controlled of all (in this case four) blanket-to-blanket printing couples 03 are in thermal contact with a first line branch 21.1, and the drive units 13 to be temperature controlled of said blanket-to-blanket printing couples 03 are in thermal contact with a second line branch 21.2, which is different from the first line branch 21.1, so that the temperature control medium circuit 16 is divided at the feed flow distributor 23 into a total of two line branches 21.1; 21.2 for the purpose of controlling the temperature of the rollers 11 and the drive units 13 of the printing unit 01.

In another advantageous embodiment of the printing unit 01 embodied as a printing tower 01, the rollers 11 to be temperature controlled of all (in this case four) printing couples 04 that interact with the same side of the web are in thermal contact with a first line branch 21.1, and the drive units 13 to be temperature controlled of said printing couples 04 that interact with said side of the web are in thermal contact with a second line branch 21.2, which is different from the first line branch 21.1. One or more switching and/or control devices (e.g., control cubicles or control cabinets (12)) can then also be incorporated into the latter branch for controlling the temperature of said devices. The same applies similarly to the printing couples 04 that interact with the other side of the web, so that for the printing unit 01, the temperature control medium circuit 16 is divided at the feed flow distributor 23 into a total of four line branches 21.1; 21.2. This embodiment is particularly advantageous in a printing unit 01 which can be divided such that the distance between side frames that support the printing couples 04 for a first side of the web and side frames that support the printing couples 04 for the second side of the web can be changed—and thus the printing unit 03 can be separated in the region of the printing points.

Particularly in the latter two embodiments, an ascending line connected to the feed flow distributor 23 and a descending line connected to the ascending line and to the return flow collector 24 are provided for the first and the second line branches 21.1; 21.2 in the printing tower 01, wherein, for example, the ascending and descending lines of the line branch(es) 21.2 that controls/control the temperature of the drive units 13 extend on the (end) side, for example, drive side, of the printing unit 01 that has the drive units, and the ascending and descending lines of the line branch(es) 21.1 that controls/control the temperature of the rollers 11 extend on the other side, for example, the operating side. In this case, the drive units 13 to be temperature controlled of the same printing couple 04 (or, in the first case, of the same blanket-to-blanket printing couple 03), for example, the drive unit(s) of the inking and/or dampening unit and the drive unit(s) of the printing couple cylinders (e.g., in this sequence), are preferably temperature controlled in series by a line loop with a removal from the ascending line and a return into the descending line. For each of the printing couples 04 to be temperature controlled by the line branch 21.2 (or, in the first case, the blanket-to-blanket printing couple 03), a line loop of this type for controlling the temperature of the drive units 13 is then provided in parallel, for example. In the case of multiple rollers 11 to be temperature controlled per printing couple 04, said rollers can, in principle, be temperature controlled in the same manner for each printing couple in series by means of one loop per printing couple 04, and in parallel for the printing couples 04 connected to the line branch 21.1. In one advantageous embodiment, however, a separate line loop, connected to the relevant ascending and descending lines, is provided in parallel for each roller 11 to be temperature controlled.

For all the stated embodiments having multiple line branches 21.i, a device for adjusting line resistance, for example, an adjustable flow control valve, not shown here, can be advantageously provided in the line branches 21.i, particularly in at least n−1 of a total of n branches. In this manner, adequate flow through all line branches 2.1.i, which under some circumstances may have different line resistance, can be ensured, for example, a single time during start-up, or even after start-up. Said devices need not be controllable or remotely actuable, and can instead be embodied as manually actuable. Also, they are adjusted not on the basis of a temperature of a component to be temperature controlled, but only to influence the distribution of the volumetric flow rates through the branches. This can be applied similarly to the arrangement of flow control valves of this type in line loops in the aforementioned embodiment involving further division into said loops. These valves can then be provided in place of or in addition to the above-mentioned flow control valves.

Therefore, for controlling operating temperature, rather than influencing the volumetric flow rate in the inner temperature control medium circuit 16 by means of a control valve on the basis of a component temperature, a temperature control medium at a lower temperature is metered into a circulating, substantially constant volumetric flow, or a part of the circulating volumetric flow is exchanged through addition and removal, because the circulating temperature control medium has exceeded a threshold temperature.

As was described above, temperature control medium (particularly temperature control medium at another, preferably lower temperature) can be metered as needed into the inner temperature control medium circuit 16 of each printing unit 01 from an external source 26, for example, an outer temperature control medium circuit 26 (or “primary circuit”), for example, a supply circuit 26, by means of the control device 18 acting on the valve 17, on the basis of a signal from the temperature sensor 19. In this manner, the inner temperature control medium circuit 16 is preferably controlled to a temperature of the temperature control medium of approximately 25° C. to 30° C.—particularly at a measuring point between valve 22 and the first component to be temperature controlled, preferably at a point downstream of the pump 17.

The supply circuit 26 is preferably also embodied as a “quasi-closed” system and has a pump 27, for example, circulating pump 27, which drives the temperature control medium, and a cold source 28 or heat sink 28, for example, a heat exchanger 28 or particularly a cooling unit 28 (or refrigerating machine), and for multiple inner temperature control medium circuits 16 each assigned to one printing unit, removal points 31 in a feed line 33 and return points 32 in a return line 34. Preferably, the supply circuit 26 or the heat exchanger 28 is operated such that the temperature control medium in the feed line 33 has a temperature of 8° to 17°, for example, particularly 10° C. to 15° C. If the cold source 28 in one advantageous embodiment is embodied as a refrigerating machine, for example, as a compression-type refrigerator, then in a particularly advantageous further development, a device, not shown here, for pre-cooling the return line can be provided in the return line 34 between the last return point 32 and the refrigerator 28. In the simplest configuration, this can be a return section of the return line 34 itself, embodied as a “register,” for example, a pipe coil, guided in the manner of a free cooler outside of the building, which return section is cooled by outside air, for example, by forced flow from a fan, and optionally by spraying with water. In another embodiment, however, a separate cooling medium circuit with a free cooler (if applicable, with the option of spraying with water) can be provided in an external mounting, said circuit being in thermal contact with the temperature control medium of the return line via a heat exchanger arranged between the last return point 32 and the refrigerating machine 28.

In the supply circuit 26, a pressure compensating vessel 29, illustrated by way of example, can be advantageously provided, which in the event of temperature fluctuation, buffers the pressure fluctuations associated with this. In contrast to the illustration, the pressure compensating vessel 29 can preferably be arranged in the feed line 33 between pump 27 and the first removal point 31. In this case, a second pressure compensating vessel 29 can advantageously be provided in the return line 34 between the last return point 32 and the cold source 28.

In an advantageous further development a valve, for example, an adjustable flow control valve, not shown, can also be provided in the supply circuit 26 between the last removal point 31 and the first return point 32, to generate a difference in pressure between feed line 33 and return line 34.

The temperature control of the printing unit(s) 01, wherein both rollers 11 and drive units 13 and/or equipment cabinet 12 are integrated into the inner temperature control circuit, then functions as follows, for example: In a phase during the off-line period, for example, in a standby mode, or in a start-up phase of the printing unit 01, the inner temperature control medium circuit 16 is operated as a closed system. The temperature control medium circulating in the inner temperature control medium circuit 16 (without addition or removal of temperature control medium from the outer temperature control medium circuit 26) is heated by the drive units 13 of printing couples 04 that are still in the print-off position, which drive units are in standby and/or are already rotating, and the temperature control medium in turn heats the connected rollers 11 to be temperature controlled. After a certain period of time—for example, after being placed in the print-on position—, when the components (11, 12, 13) to be temperature controlled become heated during operation such that the temperature of the circulating temperature control medium exceeds a threshold value that can be predefined in the control device 18 of the control circuit 19, 18, 22, temperature control medium is metered from the outer, colder temperature control medium circuit 26 into the inner temperature control medium circuit 16 by a temporary opening of the valve 17—for example, of the corresponding channel—or a corresponding amount is removed from the temperature control medium circuit 16. In this manner, the temperature of the inner temperature control medium circuit 16, and therefore the temperature of the components 11; 12; 13 that are temperature controlled by said circuit, is held constant, or at least within a permissible temperature range.

While preferred embodiments of a printing unit and of devices and methods for controlling the temperature of a printing unit, in accordance with the present invention have been described fully and completely hereinabove, it will be apparent to one of skill in the art that various changes could be made to, for example, the specific structure of the printing units and printing couples, as well as to their associated inking and dampening units, without departing from the true spirit and scope of the present invention which is accordingly to be limited only by the appended claims.

What is claimed is:

1-26. (canceled)

27. A printing unit, which has at least a plurality of printing couples (04), embodied as wet offset printing couples (04), arranged on a same side of a web (02) to be imprinted, each of said printing couples comprising an inking unit (08) with at least one roller (11) and a dampening unit (09), characterized in that an inner temperature control medium circuit is provided with a pump (17) and a temperature sensor (19), in that rollers (11) of inking units (08) of multiple printing couples (04) of said printing unit (01) arranged on a same side of a web (02) to be imprinted are in thermal contact with a same inner temperature control medium circuit (16) for controlling the temperature of said rollers, and the inner temperature control medium circuit (16) is embodied with a substantially constant circulating volumetric flow rate of temperature control medium in such a way that when the temperature control medium circulating in the inner temperature control medium circuit (16) exceeds a threshold temperature, temperature control medium at a lower temperature coming from a supply circuit (26) can be exchanged by addition and removal, in that temperature control medium from the supply circuit (26), which is embodied as an outer temperature control medium circuit (26), can be metered into the inner temperature control medium circuit (16) via at least one remotely actuable multiway mixing valve (22).

28. The printing unit according to claim 27, characterized in that at least one control valve (22) is provided in the temperature control medium circuit (16), with which valve part of the circulating volume can be replaced with temperature control medium at the lower temperature level, from the one supply circuit (26).

29. The printing unit according to claim 27, characterized in that all rollers (11) of the same type, particularly all rollers (11) configured as distribution cylinders (11), of at least all printing couples (04) of the printing unit (01) that are arranged on a same side of a web (02) to be imprinted are in thermal contact with the same inner temperature control medium circuit (16) for controlling the temperature of said rollers.

30. The printing unit according to claim 27, characterized in that the inking units (08) of the printing couples (04) each have at least two rollers (11) of the same type to be temperature controlled, and the rollers (11) of the same type to be temperature controlled in the inking unit (08) are in thermal contact with the same inner temperature control medium circuit (16).

31. The printing unit according to claim 27, characterized in that an electric drive unit (13) of said printing unit (01) and/or an electrical controlling unit (12) of said printing unit (01) is in thermal contact with the same inner temperature control medium circuit (16).

32. The printing unit according to claim 27, that at least the rollers (11) of the same type, particularly the rollers (11) embodied as distribution cylinders, of the inking units (08) of all printing couples (04) of the printing unit (01) are in thermal contact with the same inner temperature control medium circuit (16).

33. The printing unit according to claim 27, characterized in that the multiway mixing valve (22) is embodied as a four-way mixing valve (22).

34. The printing unit according to claim 27, characterized in that the temperature control medium can be metered from the outer temperature control medium circuit (26) by means of a control device (18) acting on the valve (17) on the basis of a signal from the temperature sensor.

35. The printing unit according to claim 27, characterized in that the inner temperature control medium circuit (16) is divided downstream of the pump (17) by a feed flow distributor (23) into multiple parallel line branches (21.i), which are recombined by a return flow collector (24) after coming into thermal contact with the components to be temperature controlled.

36. The printing unit according to claim 35, that rollers (11) to be temperature controlled and drive units (13) and/or controlling units (12) to be temperature controlled are arranged in different, parallel connected line branches (23.i) of the same temperature control medium circuit (16).

37. The printing unit according to claim 36, characterized in that rollers (11) to be temperature controlled of inking units (08) arranged on different sides of the web (02) are functionally connected to different line branches (23.i) of the same temperature control medium circuit (16).

38. The printing unit according to claim 35, that at least one roller (11) to be temperature controlled and at least one drive unit (13) and/or controlling unit (12) to be temperature controlled are arranged in series in a same line branch (21.i) of the temperature control medium circuit (16).

39. The printing unit according to any one of claim 35, characterized in that in at least one of the line branches (23.i), particularly in at least n−1 of a total of n line branches (23.i), a device for adjusting line resistance is provided.

40. The printing unit according to claim 27, characterized in that the outer temperature control medium circuit (26) has a pump (27) and a cold source (28).

41. The printing unit according to claim 27, characterized in that the outer temperature control medium circuit has removal points (31) for multiple inner temperature control medium circuits (16), each assigned to one printing unit (01).

42. The printing unit according to claim 27, characterized in that the printing unit (01) is embodied as a printing tower, through which a web (02) passes substantially vertically, comprising at least eight printing couples (04) and/or four blanket-to-blanket printing couples (03) arranged one above the other.

43. The printing unit according to claim 42, characterized in that rollers (11) of the inking units (08) of all printing couples (04) of the printing tower (01) are in thermal contact with the same inner temperature control medium circuit (16).

44. A method for controlling the temperature of rollers of a printing unit, which comprises at least a plurality of printing couples (04), embodied as wet offset printing couples (04), arranged on a same side of a web (02) to be imprinted, each of said printing couples having an inking unit (08) with at least one roller (11) and a dampening unit (09), characterized in that rollers (11) of inking units (08) of multiple printing couples (04) arranged on a same side of a web (02) to be imprinted are temperature controlled by a same inner temperature control medium circuit (16), wherein a substantially constant volumetric flow rate of temperature control medium circulates in the inner temperature control medium circuit (16), and for maintaining a permitted temperature or for achieving a desired temperature, part of the volume circulating in the inner temperature control medium circuit (16) is replaced by temperature control medium at a different temperature level, from a supply circuit (26).

45. The method according to claim 44, characterized in that in a phase in which the printing unit (01) is off-line, or during a start-up phase of the printing unit, the inner temperature control medium circuit (16) is operated as a closed system and the temperature control medium circulates in the inner temperature control medium circuit (16) without addition or removal of temperature control medium.

46. The method according to claim 45, characterized in that in a phase in which the printing unit (01) is off-line, or during a start-up phase of the printing unit, heat is introduced into the circulating temperature control medium through an activatable heating device which is functionally connected to the inner temperature control medium circuit (16).

47. The method according to claim 44, characterized in that temperature control medium from an outer temperature control medium circuit (26) is metered into the inner temperature control medium circuit (16) as soon as the temperature of the temperature control medium circulating in the inner temperature control medium circuit (16) exceeds a definable threshold level.
